(19) United States
(12) Patent Application Publication
(10) Pub. No.: US 2026/0028855 A1
(43) Pub. Date: Jan. 29, 2026

(54) PADLOCK WITH RESET FUNCTION

(71) Applicant: The Sun Lock Company Limited, Tuen Mun (HK)

(72) Inventor: Karl Lai, Tai Po (HK)

(21) Appl. No.: 19/269,170

(22) Filed: Jul. 15, 2025

Related U.S. Application Data
(60) Provisional application No. 63/675,511, filed on Jul. 25, 2024.

(51) Int. Cl. E05B 37/02; E05B 37/00

(52) U.S. Cl. CPC E05B 37/025; E05B 37/0034; E05B 37/0058

(57) ABSTRACT

A padlock according to an exemplary aspect of the present invention includes a lock body, a reset lever configured to operate the padlock between a reset stage and a non-reset stage, a shackle operatively coupled to the lock body and at least one dial. The lock body may include at least one window and the reset lever may include at least one wing, and the at least one window is configured to allow each wing of the reset lever to pass through the corresponding window of the lock body. When the dials are all in the correct code, the reset lever is configured to activate the padlock from the non-reset stage to the reset stage.

### CROSS-REFERENCE TO RELATED APPLICATIONS

This application claims priority to U.S. Provisional Appl. No. 63/675,511 filed Jul. 25, 2024, which is hereby incorporated by reference in its entirety.

### BACKGROUND OF THE INVENTION

### 1. Field of the Invention

The present invention generally relates to padlocks, and more particularly to a padlock having a reset function comprising a reset level to control the reset mechanism of the padlock.

### 2. Related Art

The combination padlock disclosed in U.S. Pat. No. 7,140,209 to Mr. Eric Lai entitled Padlock with Fully Integrated Dual Locking Systems, which is hereby incorporated by reference in its entirety, is one of the most commonly used travel padlocks. The conventional combination padlock reset process requires a user to pull the shackle upward, then rotate the shackle a certain number of degrees, then push the shackle downward and then turn to the combination dials to set a new code for the combination mechanism of the combination padlock. The problem is that during normal usage of combination padlock the user may accidentally push the shackle downward and inadvertently reset and/or reconfigure the code for the combination mechanism. Therefore, what is needed is a combination padlock that allows for the resetting and/or reconfiguration of the code for the combination mechanism without the risk that the padlock will enter the reset mode during normal usage of the padlock. According to an exemplary embodiment of the present invention, a padlock having a reset lever to control the reset mechanism of the padlock is provided.

### SUMMARY OF THE INVENTION

An object of the present invention is to provide a combination padlock that allows for resetting and/or reconfiguration of the code for the combination mechanism without the risk that the padlock will enter the reset mode during normal usage of the padlock.

Another object of the present invention is that during normal operation of the padlock the user may pull and push the shackle upward and downward without accidentally changing the combination code.

Still another object of the present invention is to eliminate or at least significantly reduce the likelihood of accidentally changing of the combination code.

It is yet another object of the present invention that when the dials are not in correct lock open code, the reset lever cannot be pushed from non-reset stage to reset stage, and the code cannot be changed.

It is an object of the present invention that the only way to turn the padlock from non-reset stage to reset stage is only when the dials are in correction combination and also the reset lever is extended outward such that the tongue is extended outward.

It is another object of the present invention that when the shackle is in the open position, the pushing of the shackle downward alone will not cause activation to the reset stage of the padlock.

It is still another object of the present invention to provide a visual indicator of when the padlock is in the reset stage.

In accordance with these and other objects of the present invention, a padlock is provided having a lock body, a shackle operatively coupled to the lock body, a reset lever configured for movement in a first direction to operate the padlock between a reset stage and a non-reset stage, a reset slider operatively connected to the reset lever and moveable in a second direction at least substantially perpendicular to the first direction to operate the padlock between the reset stage and the non-reset stage, a dial positioned within the lock body for rotational movement about the shackle, and a clutch configured for operative coupling to the one dial and positioned for rotational movement about the shackle.

According to this and other exemplary aspects of the present invention, the clutch is configured for movement in a third direction at least substantially parallel to the second direction.

According to this and other exemplary aspects of the present invention, wherein when the clutch moves in the third direction the clutch is disengaged from the dial and the padlock is in the reset stage.

According to this and other exemplary aspects of the present invention, the lock body may include at least one window and the reset lever may include at least one wing, and wherein the at least one window is configured to allow each wing of the reset lever to pass through the corresponding window of the lock body.

According to this and other exemplary aspects of the present invention, the lock body may include a protrusion and the reset lever may include a tongue, wherein the protrusion is configured to allow the tongue of the reset lever to extended outward when the padlock is in the reset stage, and wherein the tongue is positioned within the protrusion when the padlock is in the non-reset stage.

According to this and other exemplary aspects of the present invention, the reset lever may include a lever slope, and the reset slider may include a slider slope configured for operative engagement with the lever slope of the reset lever, wherein when the padlock is in the non-reset stage engagement of the slider slope with the lever slope inhibits movement of the reset lever in the first direction, and wherein when the padlock is in the reset stage the slider slope is disengaged from the lever slope.

According to this and other exemplary aspects of the present invention, the dial may include teeth, and the clutch may include an extended-fin configured for operative engagement with the teeth of the dial, wherein when the clutch is moved in the third direction the extended-fin is disengaged from the teeth of the dial and the padlock is operated to the reset stage, and wherein when the extended-fin is disengaged from the teeth of the dial rotation of the dial is not transferred to the clutch.

According to this and other exemplary aspects of the present invention, the dial may include teeth, and the clutch may include an extended-fin configured for operative engagement with the teeth of the dial, wherein engagement of the extended-fin with the teeth is configured to transfer rotation of the dial about the shackle to rotation of the clutch about the shackle.

According to this and other exemplary aspects of the present invention, the shackle may include a protrusion, and the clutch may include an opening-gate, wherein when the opening-gate of the clutch is aligned with the protrusion of the shackle the padlock may be operated to an unlocked mode and the reset stage.

According to this and other exemplary aspects of the present invention, the padlock is operated to the unlocked mode, the reset lever is configured to operate the padlock from the non-reset stage to the reset stage by movement of the reset lever in the first direction.

According to this and other exemplary aspects of the present invention, the reset lever may include a flat-end, and the reset slider may include a reset-lever-side-surface configured for operative contact with the flat-end when the padlock is in the reset mode, wherein the flat-end of the reset lever inhibits movement of the reset slider when the reset lever is moved in the first direction so that the padlock can be maintained in the reset mode.

According to this and other exemplary aspects of the present invention, the reset slider may include a clutch-side surface positioned at least substantially opposite the reset-lever-side-surface and configured for operative contact with the clutch.

According to this and other exemplary aspects of the present invention, the padlock may also include a shackle-spring plate operatively connected to the clutch and a shackle spring configured to urge the shackle-spring plate in a fourth direction opposite the third direction.

According to this and other exemplary aspects of the present invention, the wing of the reset lever is extruded outward to let the user to push the reset lever to operate the padlock from the non-reset stage to the reset stage.

According to this and other exemplary aspects of the present invention, the reset lever does not require a user to hold the reset lever during the reset stage.

According to this and other exemplary aspects of the present invention, the padlock may further include at least one additional dial and a correct combination code enterable by positioning of each of the dials to a predetermined orientation, wherein the padlock may be operated from the non-reset stage to the reset stage when the correct combination code has been entered for the padlock.

According to this and other exemplary aspects of the present invention, the correct combination code may be reconfigured to another correct combination code when the padlock is operated to the reset stage.

In accordance with these and other objects of the present invention, a padlock is provided having a lock body, a reset lever configured to operate the padlock between a reset stage and a non-reset stage, a shackle operatively coupled to the lock body, and at least one dial.

According to this and other exemplary aspects of the present invention, the lock body comprises at least one window and the reset lever comprises at least one wing, and wherein the at least one window is configured to allow each wing of the reset lever to pass through the corresponding window of the lock body.

According to this and other exemplary aspects of the present invention, the lock body comprises a protrusion and the reset lever comprises a tongue, wherein the protrusion is configured to allow the tongue of the reset lever to extended outward when the padlock is in the reset stage, and wherein the tongue is positioned within the protrusion when the padlock is in the non-reset stage.

According to this and other exemplary aspects of the present invention, when the shackle is in the closed position within the lock body, as long as the dials are all in the correct code, the reset lever is configured to activate the padlock from the non-reset stage to the reset stage.

According to this and other exemplary aspects of the present invention, when the shackle is in an open position at least partially separated from the lock body, as long as the dials are all in the correct code, the reset lever is configured to activate the padlock from the non-reset stage to the reset stage.

According to this and other exemplary aspects of the present invention, the wing of the reset lever is extruded outward to let the user to push the reset lever to operate the padlock from the non-reset stage to the reset stage.

According to this and other exemplary aspects of the present invention, the reset lever does not require a user to hold the reset lever during the reset stage.

According to this and other exemplary aspects of the present invention, when the shackle is in the open position, the pushing of the shackle downward towards the lock body alone will not cause operation of the padlock to the reset stage of the padlock, wherein the padlock can only be operated from the non-reset stage to the reset stage when the dials are in the correction combination and the reset lever is extended outward such that the tongue is extended outward.

According to this and other exemplary aspects of the present invention, as the reset lever of the tongue is extended outward, the turning of the dials will cause the padlock to change the correct code combination.

According to this and other exemplary aspects of the present invention, if the dials are not in the correct lock open code, the reset lever cannot be pushed from the non-reset stage to the reset stage, and the padlock combination the code cannot be changed.

The reference numbers and corresponding elements are summarized below:

10 padlock
20 reset lever
21 wing
22 tongue
23 slope
24 flat-end
30 body rear side
31 protrusion
32 window (not shown due to the point of view of the drawings)
33 reset-slider-receiving-hole
34 dial slot
35 shackle-spring-plate-hole
40 body front side
41 protrusion
42 window
43 reset-slider-receiving-hole
44 dial slot
45 shackle-spring-plate-hole
50 shackle
51 protrusions
60 dial
61 teeth
70 clutch
71 extended-fin
72 opening-gate (not shown)
80 shackle-spring
81 spring-assemble side
90 reset slider
91 slope
92 clutch-side surface
93 reset-lever-side surface
100 shackle spring

### BRIEF DESCRIPTION OF THE DRAWINGS

For a fuller understanding of the nature and object of the present invention, reference should be had to the following detailed description taken in connection with the accompanying drawings, in which:

FIG. 1. is a perspective view of an exemplary padlock according to an aspect of the present invention in which the padlock is in a non-reset stage;

FIG. 2 is a perspective view of the exemplary padlock according to an aspect of the present invention in which the padlock is in a reset stage;

FIG. 3 is a partial cut-away front view of the exemplary padlock according to an aspect of the present invention in which the padlock is in the non-reset stage; and

FIG. 4 is a partial cut-away front view of the exemplary padlock according to an aspect of the present invention in which the padlock is in the reset stage.

### DETAILED DESCRIPTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

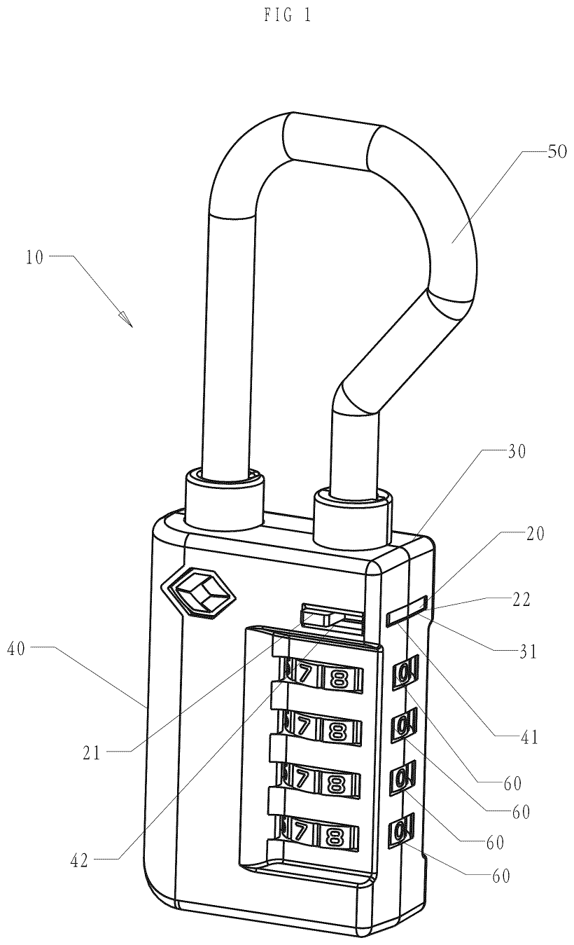

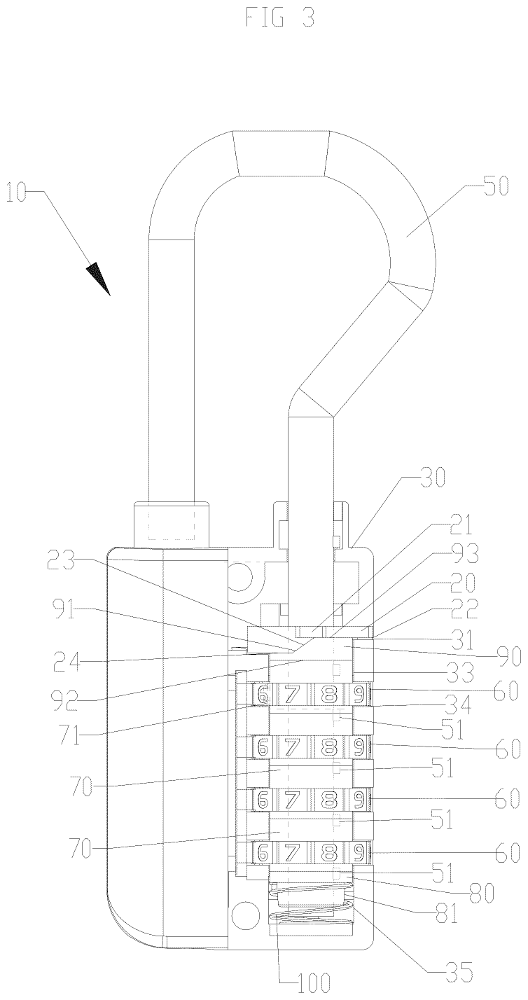

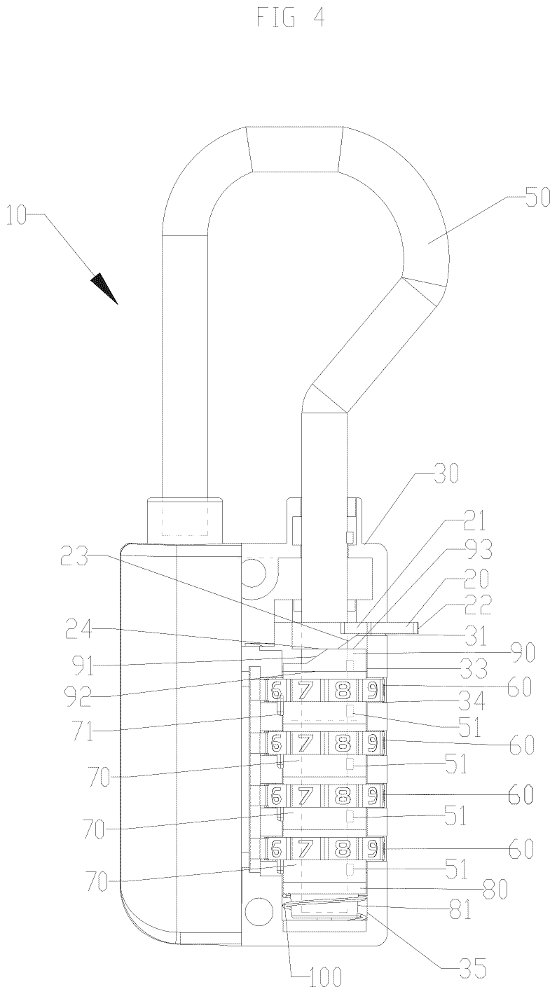

Referring now to FIGS. 1-4, therein illustrated is an exemplary embodiment of a padlock, generally indicated by reference numeral 10, according to an aspect of the present invention. The padlock 10 may be a travel padlock having a combination mechanism and a key mechanism for operation of the padlock 10 between a locked mode and an unlocked mode. Either the combination mechanism or the key mechanism may be independently able to operate the padlock 10, it is understood the present invention is not limited to padlock having both a combination mechanism and a key mechanism. The padlock 10 may be composed of a body rear side 30 and a body front side 40 coupled together to form a lock body configured to at least partially house the components of the padlock 10. The padlock 10 may also include a shackle 50 movable between a position in which the padlock 10 is in the locked mode and a position in which the padlock 10 is in the unlocked mode. The combination mechanism and/or key mechanism are configured to allow operation of the shackle 50 between the respective positions, for example, in the locked mode both ends of the shackle 50 are retained within the lock body, while in the unlocked mode at least one end of the shackle 50 may be separated from the lock body. The shackle 50 may include one or more protrusions 51 extending therefrom, and at least one of the protrusions 51 is positioned within the locked body formed by the body rear side 30 and the body front side 40. The padlock 10 may also include a reset lever 20 having at least one wing 21 and a tongue 22. The reset lever 20 may also include a slope 23 and a flat-end 24 positioned substantially adjacent to the slope 23. The body front side 40 has a window 42 formed therein configured for receipt of one of the at least one wings 21 of the reset lever 20. The body rear side 30 may also have a window 32 (not shown) formed therein and configured for receipt of another of the at least one wings 21 of the reset lever 20. The body front side 40 and the body rear side 30 may also include a protrusion 41/31 formed therein to form an opening to allow passage of the tongue 22 of the reset lever 20 from inside of the lock body to outside of the lock body to indicate whether the padlock 10 is in the non-reset stage or the reset stage. The padlock 10 may also include a reset slider 90 configured for operative engagement with the reset lever 20. The reset slider 90 may include a slope 91 configured for operative engagement with the slope 23 of the reset lever 20, a clutch-side-surface 92 and a reset-level-side-surface 93 opposite the clutch-side-surface 92 and oriented towards the reset lever 20. The body rear side 30 and body front side 40 may each include a reset-slider-receiving-hole 33/43 formed therein to accommodate the reset slider 90 and movement of the reset slider 90 within the lock body. The combination mechanism of the padlock 10 may include at least one dial 60 configured for input of the correct combination code of the padlock 10 in order to allow operation of the padlock 10 from the locked mode to the unlocked mode. The body rear side 30 and the body front side 40 may each include a dial slot 34/44 for each of the dials 60 of the padlock 10. Each of the dials 60 has one or more indicia, which may be in the form of numbers, symbols, letters, colors or the like. Each of the dials 60 includes a plurality of teeth 61, in which the number of teeth corresponds to the number of indicia on each dial 60. The padlock 10 may also include a clutch 70 corresponding to each dial 60, and each clutch 70 may include an extended-fin 71 configured for engagement with the teeth 61 of the corresponding dial, and an opening gate 72 (not shown) configured for alignment with the corresponding protrusion 51 of the shackle 50 when a correct combination code for the padlock 10 has been entered on all of the dials 60 and the padlock 10 may be operated to the unlocked mode. The clutches 70 may be positioned in a stack between the reset slider 90 and a shackle-spring-plate 80 positioned in a shackle-spring-plate-hole 35/45 in each of the body rear side 30 and body front side 40. The shackle-spring-plate 80 may include a spring-assemble side 81 configured for engagement with a shackle spring 100 that urges the shackle-spring-plate 80 and stack of clutches 70 against the clutch-side surface 92 of the reset slider 90. Operation of the reset lever 20 allows the padlock 10 to be operated between the non-reset stage and the reset stage.

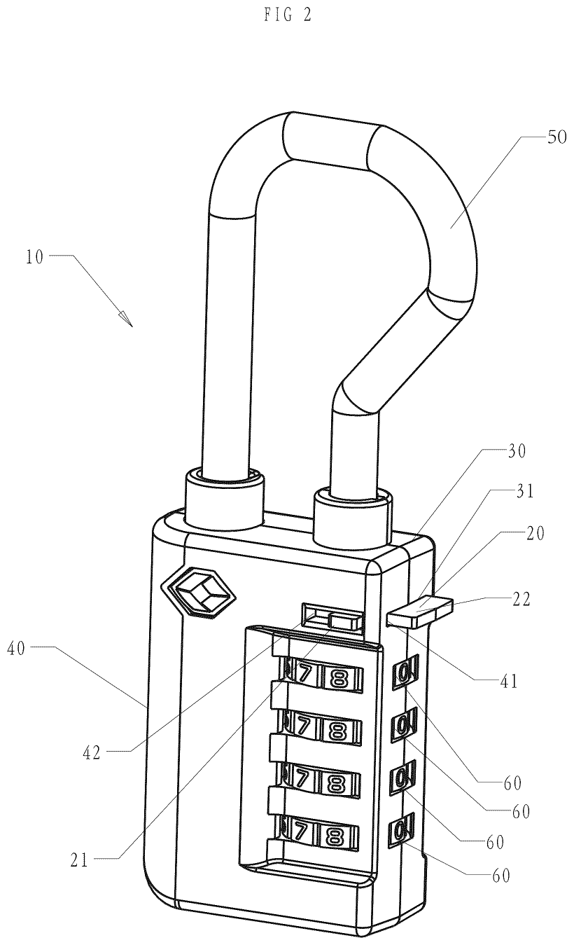

Referring still to FIGS. 1-4, the reset level 20 of the padlock 10 reduces and/or eliminates accidentally changing the correct combination code of the combination mechanism of the padlock 10. When all of the dials 60 of the combination mechanism have been set in the correct combination code for the padlock 10, the user can pull the wing 21 of the reset lever 20 rightward such that the tongue 22 of the reset lever will exit through the protrusion 31/41 of the lock body 30/40, as shown in FIG. 2. This movement of the reset lever 20 operates the padlock 10 to the reset stage. In order to operate the padlock 10 to the reset stage, the padlock 10 must first be operated to the unlocked mode by entering the correct combination code for the padlock 10 on all of the dials 60. When the correct combination code for the padlock 10 has been entered, the protrusions 51 of the shackle 50 are aligned with the corresponding opening gate 72 of each clutch 70 so that the clutches 70 no longer restrict movement of the shackle 50 by interfering with one or more of the protrusions 51. When the opening gates 72 are all aligned with corresponding protrusions 51, the shackle 50 may be moved away from the padlock 10 to operate the padlock 10 to the unlocked mode. In addition, the wing 21 of the reset lever 20 can be moved so that the tongue 22 of the reset lever 20 extends out of the lock body of the padlock 10. The rectilinear movement of the reset lever 20 in the lock body of the padlock 10 also causes the slope 23 of the reset lever 20 to disengage from the slope 91 of the reset slider 90, and the flat-end 24 of the reset lever 20 to contact the reset-lever-side-surface 93 of the reset slider 90 so that the clutch-side surface 92 of the reset slider 90 urges the upper most clutch 70 in a direction at least substantially perpendicular to the movement of the reset lever 20. The movement of the reset slider 90 in a direction at least substantially perpendicular to the movement of the reset lever 20 causes compression of the shackle spring 100, as a result of corresponding movement of the stack of clutches 70 and shackle-spring-plate 80, and disengagement of the extended-fins 71 of the clutches 70 from the corresponding teeth 61 of the dials 60. In contrast, when the padlock 10 is in the locked mode, the opening gates 72 of the clutches 70 are not aligned with the corresponding protrusions 51 of the shackle 50 and the shackle 50 cannot be pulled open, and the reset lever 20 cannot cause movement of the reset slider 90 to move the stack of clutches 70 to disengage the extended-fins 71 of the clutches 70 from the corresponding teeth 61 of the dials 60. In the reset stage, as the tongue 22 of the reset lever 20 is extended outward the user can now turn the dials 60 to set the new correct combination code. The reset lever 20 is to allow the user to have both hands free for turning of the dials 60 in the entire recode process. After setting the new correct combination code, the user can push the reset lever 20 leftward such that the tongue 22 will return to inside of the protrusion 31/41 of the lock body 30/40, as shown in FIG. 1. The wing 21 will be sliding inside the window 32/42 of the lock body 30/40 in any mode. As a result of movement of the reset lever 20 so that the tongue 22 is returned to within the lock body of the padlock 10, the flat-end 24 of the reset lever 20 no longer contacts the reset-lever-side-surface 93 of the reset slider 90, and the slope 23 of the reset lever 20 is again in contact with the slope 91 of the reset slider 90. This configuration releases the stack of clutches 70, and the shackle spring 100 urges the stack of clutches 70 against the clutch-side-surface 92 of the reset slider 90 so that the extended-fins 71 of the clutches 70 reengage with the corresponding teeth 61 of the dials 60 so that rotation of the dials 60 is once against imparted to the corresponding clutches 70. When rotation of the dials 60 is transferred to the clutches 70 as a result of engagement of the extended-fins 71 with corresponding teeth 61, the padlock 10 is in the non-reset stage, and it is not possible to reset and/or reconfigure the correct combination code for the padlock 10. In the entire reset process, the user is not required to move the shackle 50 to reset and/or reconfigure the correct combination code. The shackle 50 could be in locked mode position or even in unlocked mode position, as long as the dials 60 are set to the correct combination code and the reset lever 20 has been actuated such that the tongue 22 is extended outward then the padlock 10 will be in the reset stage. During normal usage of the padlock 10, the user may pull and push the shackle 50 upward and downward without accidentally changing and/or resetting of the correct combination code.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed is:

1. A padlock, comprising:
a lock body;
a shackle operatively coupled to the lock body;
a reset lever configured for movement in a first direction to operate the padlock between a reset stage and a non-reset stage;
a reset slider operatively connected to the reset lever and moveable in a second direction at least substantially perpendicular to the first direction to operate the padlock between the reset stage and the non-reset stage;
a dial positioned within the lock body for rotational movement about the shackle; and
a clutch configured for operative coupling to the one dial and positioned for rotational movement about the shackle;
wherein the clutch is configured for movement in a third direction at least substantially parallel to the second direction; and
wherein when the clutch moves in the third direction the clutch is disengaged from the dial and the padlock is in the reset stage.

2. The padlock according to claim 1, wherein the lock body comprises at least one window and the reset lever comprises at least one wing, and wherein the at least one window is configured to allow each wing of the reset lever to pass through the corresponding window of the lock body.

3. The padlock according to claim 2, wherein the lock body comprises a protrusion and the reset lever comprises a tongue, wherein the protrusion is configured to allow the tongue of the reset lever to extended outward when the padlock is in the reset stage, and wherein the tongue is positioned within the protrusion when the padlock is in the non-reset stage.

4. The padlock according to claim 1, wherein the reset lever comprises a lever slope, and the reset slider comprises a slider slope configured for operative engagement with the lever slope of the reset lever, wherein when the padlock is in the non-reset stage engagement of the slider slope with the lever slope inhibits movement of the reset lever in the first direction, and wherein when the padlock is in the reset stage the slider slope is disengaged from the lever slope.

5. The padlock according to claim 1, wherein the dial comprises teeth, and the clutch comprises an extended-fin configured for operative engagement with the teeth of the dial, wherein when the clutch is moved in the third direction the extended-fin is disengaged from the teeth of the dial and the padlock is operated to the reset stage, and wherein when the extended-fin is disengaged from the teeth of the dial rotation of the dial is not transferred to the clutch.

6. The padlock according to claim 1, wherein the dial comprises teeth, and the clutch comprises an extended-fin configured for operative engagement with the teeth of the dial, wherein engagement of the extended-fin with the teeth is configured to transfer rotation of the dial about the shackle to rotation of the clutch about the shackle.

7. The padlock according to claim 1, wherein the shackle comprises a protrusion, and the clutch comprises an opening-gate, wherein when the opening-gate of the clutch is aligned with the protrusion of the shackle the padlock may be operated to an unlocked mode and the reset stage.

8. The padlock according to claim 7, wherein the padlock is operated to the unlocked mode, the reset lever is configured to operate the padlock from the non-reset stage to the reset stage by movement of the reset lever in the first direction.

9. The padlock according to claim 1, wherein the reset lever comprises a flat-end, and the reset slider comprises a reset-lever-side-surface configured for operative contact with the flat-end when the padlock is in the reset mode, wherein the flat-end of the reset lever inhibits movement of the reset slider when the reset lever is moved in the first direction so that the padlock can be maintained in the reset mode.

10. The padlock according to claim 9, wherein the reset slider comprises a clutch-side surface positioned at least substantially opposite the reset-lever-side-surface and configured for operative contact with the clutch.

11. The padlock according to claim 1, further comprising a shackle-spring plate operatively connected to the clutch and a shackle spring configured to urge the shackle-spring plate in a fourth direction opposite the third direction.

12. The padlock according to claim 2, wherein the wing of the reset lever is extruded outward to let the user to push the reset lever to operate the padlock from the non-reset stage to the reset stage.

13. The padlock according to claim 9, wherein the reset lever does not require a user to hold the reset lever during the reset stage.

14. The padlock according to claim 1, further comprising at least one additional dial and a correct combination code enterable by positioning of each of the dials to a predetermined orientation, wherein the padlock may be operated from the non-reset stage to the reset stage when the correct combination code has been entered for the padlock.

15. The padlock according to claim 14, wherein the correct combination code may be reconfigured to another correct combination code when the padlock is operated to the reset stage.
